(19) United States
(12) Patent Application Publication
(10) Pub. No.: US 2026/0186529 A1
(43) Pub. Date: Jul. 2, 2026

(54) MULTIFUNCTIONAL MAGNETIC SUCTION TABLET COMPUTER PROTECTIVE SHELL

(71) Applicant: Shenzhen Atcool Technology Co., Ltd., Shenzhen (CN)

(72) Inventor: Zheng Weizhong, Shenzhen (CN)

(21) Appl. No.: 19/027,419

(22) Filed: Jan. 17, 2025

(30) Foreign Application Priority Data
Dec. 27, 2024 (CN) 2024232452938

(51) Int. Cl. G06F 1/16

(52) U.S. Cl. CPC G06F 1/1629; G06F 1/166

(57) ABSTRACT

A multifunctional magnetic suction tablet computer protective shell is provided, which includes a shell, the shell includes a bottom plate and an outer protective pad. The bottom plate is embedded with a first magnet corresponding to a built-in magnet of a tablet computer. The first magnet is configured to magnetically cooperate with the built-in magnet of the tablet computer. Four corners of the bottom plate are respectively provided with protective corners that correspond to four corners of the tablet computer. The outer protective pad is wrapped around the bottom plate and the first magnet. The present disclosure can effectively solve the inconvenience faced by tablet computers when disassembling and assembling with traditional shells and a problem of tablet computer wear caused by this process, thereby greatly improving the convenience of disassembling and assembling tablet computers with shells and avoiding possible damage to tablet computers during the disassembly and assembly process.

### CROSS-REFERENCE TO RELATED APPLICATIONS

This application claims priority to Chinese Patent Application No. 202423245293.8 filed on Dec. 27, 2024, which is hereby incorporated by reference in its entirety.

### TECHNICAL FIELD

The present disclosure relates to the field of tablet computer protective shells technologies, and in particular, to a multifunctional magnetic suction tablet computer protective shell.

### BACKGROUND

A tablet computer protective shell is used to cover a tablet computer and provide protection. It generally includes a shell and a flip cover plate. The shell is fixed to a back plate of the flip cover plate, and when the cover plate of the flip cover plate is closed, it can provide protection for a front screen of the tablet computer.

The edges of the bottom plate of the traditional tablet computer protective shell are surrounded by edge sleeves, which are fixed around the tablet computer by a clamp sleeve to achieve a connection between the bottom plate and the tablet computer. However, this connection way renders the assembly and disassembly of the tablet computer and the shell more complicated, and during the disassembly and assembly process, corners of the tablet computer are prone to wear and tear. Besides that, due to the shell being fixed on the back plate of the flip cover plate, it cannot be used independently, which also imposes certain limitations on the placement of the tablet computer.

### SUMMARY

In response to deficiencies in existing technology, the present disclosure provides a multifunctional magnetic suction tablet computer protective shell, aimed at solving an inconvenience faced by tablet computers when disassembling and assembling with traditional shells and a problem of easy wear and tear caused by this process, thereby greatly improving the convenience of disassembling and assembling a tablet computer with a shell and avoiding possible damage to the tablet computer during the disassembly and assembly process.

To achieve the above objectives, the present disclosure adopts the following technical solution.

A multifunctional magnetic suction tablet computer protective shell, including a shell, where the shell includes a bottom plate and an outer protective pad, the bottom plate is embedded with a first magnet corresponding to a position of a built-in magnet of a tablet computer, and the first magnet is configured to magnetically cooperate with the built-in magnet of the tablet computer; four corners of the bottom plate are respectively provided with four protective corners that correspond to four corners of the tablet computer, and the outer protective pad is wrapped around the bottom plate and the first magnet.

In some embodiments of the present disclosure, a second magnet is embedded in a middle of the bottom plate, and there is a gap between the second magnet and the first magnet.

In some embodiments of the present disclosure, the bottom plate includes an outer frame plate and an inner plate located inside the outer frame plate, and the four protective corners are integrally formed on four outer corners of the outer frame plate, a hardness of the inner plate is higher than a hardness of the outer frame plate.

In some embodiments of the present disclosure, the outer frame plate is provided with an avoidance hole adapted to a camera module of the tablet computer.

In some embodiments of the present disclosure, the inner plate is a fiberglass plate, and the outer frame plate is a PC plate.

In some embodiments of the present disclosure, the multifunctional magnetic suction tablet computer protective shell further includes a flip cover plate, where the flip cover plate includes a cover plate, a back plate, a buckle, and a connection pad, where the cover plate, the back plate, and the buckle are sequentially spaced apart, the connection pad is wrapped on the cover plate, the back plate, and the buckle, so that the flip cover plate forms a detachable structural component wrapped around the shell; a third magnet is embedded in a middle of the back plate, where the third magnet is configured to magnetically cooperate with the second magnet, and the buckle is detachably connected to the cover plate.

In some embodiments of the present disclosure, the back plate is made of magnetic iron material.

In some embodiments of the present disclosure, the cover plate includes a first cover plate body arranged near the back plate, a third cover plate body arranged far away from the back plate, and a second cover plate body located between the first cover plate body and the third cover plate body, where a first cover plate magnet is embedded on one side of the first cover plate body near the back plate, and a second cover plate magnet and a third cover plate magnet are embedded on one side of the third cover plate body far away from the back plate; the third cover plate magnet is capable of magnetically cooperating with the first cover plate magnet.

In some embodiments of the present disclosure, there are two rows of second cover plate magnets arranged along a width direction of the third cover plate body, the buckle is embedded with lap joint magnets that magnetically cooperate with the two rows of second cover plate magnets.

In some embodiments of the present disclosure, a material of the connection pad is leather, silicone or polyester fabric.

The beneficial effects of the present disclosure are as following.

The present disclosure provides a multifunctional magnetic suction tablet computer protective shell, which can adsorb the tablet computer onto the shell by a magnetic suction of the first magnet with the built-in magnet of the tablet computer. At the same time, four protective corners are used to limit the four corners of the tablet computer, which can improve a convenience of assembling and disassembling the tablet computer and the shell and avoid wear on edges and corners of the tablet computer during the assembly process of the tablet computer and the shell.

The present disclosure provides a multifunctional magnetic suction tablet computer protective shell, which can be attached to the back plate by cooperating with the first magnet, the second magnet, and the back plate magnet. At the same time, due to many magnetic suction points, the placement angle of the shell can be varied.

### BRIEF DESCRIPTION OF DRAWINGS

In order to provide a clearer explanation of the specific implementation mode of the present disclosure or the technical solution in the prior art, a brief introduction will be given to the accompanying drawings required for the specific implementation mode or prior art description. In all drawings, similar elements or parts are generally identified by similar reference numerals. In the attached drawings, each component or part may not be drawn in actual proportion.

FIG. 1 is a front view of a multifunctional magnetic suction tablet computer protective shell in Embodiment 1 of the present disclosure.

FIG. 2 is a front view of a bottom plate in FIG. 1.

FIG. 3 is a back view of the bottom plate in FIG. 1.

FIG. 4 is a front view of the multifunctional magnetic suction tablet computer protective shell in Embodiment 2 of the present disclosure.

FIG. 5 is a front view of an unfolded flip cover plate in FIG. 4.

FIG. 6 is a use schematic diagram of the multifunctional magnetic suction tablet computer protective shell in different states according to Embodiment 2 of the present disclosure.

FIG. 7 is a use schematic diagram of the multifunctional magnetic suction tablet computer protective shell in different states according to Embodiment 2 of the present disclosure.

FIG. 8 is a use schematic diagram of the multifunctional magnetic suction tablet computer protective shell in different states according to Embodiment 2 of the present disclosure.

Numeral reference: shell 100, outer frame plate 110, first magnet 111, protective corner 112, avoidance hole 113, inner plate 120, second magnet 121, outer protective pad 130, flip cover plate 200, cover plate 210, first cover plate body 211, second cover plate body 212, third cover plate body 213, first cover plate magnet 214, second cover plate magnet 215, third cover plate magnet 216, dormancy magnet 217, back plate 220, third magnet 221, buckle 230, lap joint magnet 231, connection pad 240.

### DESCRIPTION OF EMBODIMENTS

Below, a detailed description of the embodiments of the technical solution of the present disclosure will be provided in combination with the accompanying drawings. The following embodiments are only used to illustrate the technical solution of the present disclosure more clearly, and therefore are only examples, and cannot be used to limit the protection scope of the present disclosure.

It should be noted that, unless otherwise specified, the technical or scientific terms used in the present application should have the usual meanings understood by those skilled in the art to which the present disclosure belongs.

Embodiment 1: as shown in FIGS. 1-3, this embodiment of the present disclosure provides a multifunctional magnetic suction tablet computer protective shell, which includes a shell 100. The shell 100 includes a bottom plate and an outer protective pad 130. The bottom plate is embedded with a first magnet 111 corresponding to a position of a built-in magnet of a tablet computer. The first magnet 111 is configured to magnetically cooperate with the built-in magnet of the tablet computer. Four corners of the bottom plate are respectively provided with four protective corners 112 that are located at four corners of the tablet computer. The outer protective pad 130 is wrapped around the bottom plate and the first magnet 111.

In this embodiment of the present disclosure, the protective corners 112 are circular arc corners in contact with edges of the tablet computer.

In this embodiment of the present disclosure, there are a plurality of first magnets 111, which correspond one-to-one with the built-in magnets of the tablet computer.

The present disclosure provides a multifunctional magnetic suction tablet computer protective shell, which can adsorb the tablet computer onto the shell 100 by a magnetic suction of the first magnet 111 with the built-in magnet of the tablet computer. At the same time, four protective corners 112 are used to limit the four corners of the tablet computer, which can improve a convenience of assembling and disassembling the tablet computer and the shell 100, and avoid wear on edges and corners of the tablet computer during the assembly process of the tablet computer and the shell.

In this embodiment of the present disclosure, a second magnet 121 is embedded in a middle of the bottom plate, and there is a gap between the second magnet 121 and the first magnet 111. The second magnet 121 is distributed in a ring shape. Providing the second magnet 121 can place the shell 100 together with the tablet computer on a magnetic attraction part, such as placing the shell 100 on a flip cover plate 200 (as shown in FIGS. 6-8) or on a magnetic attraction bracket.

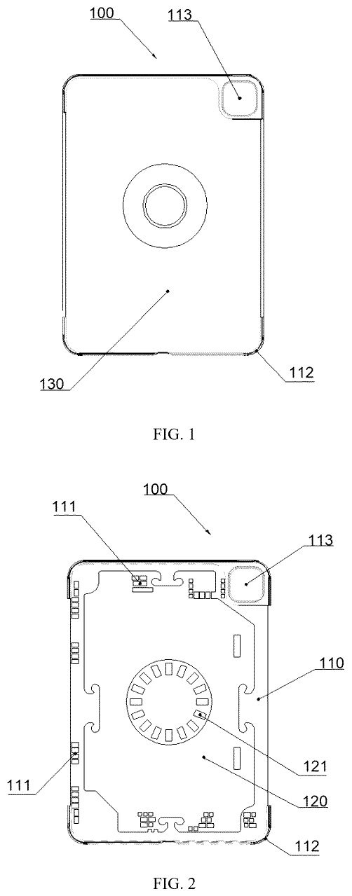

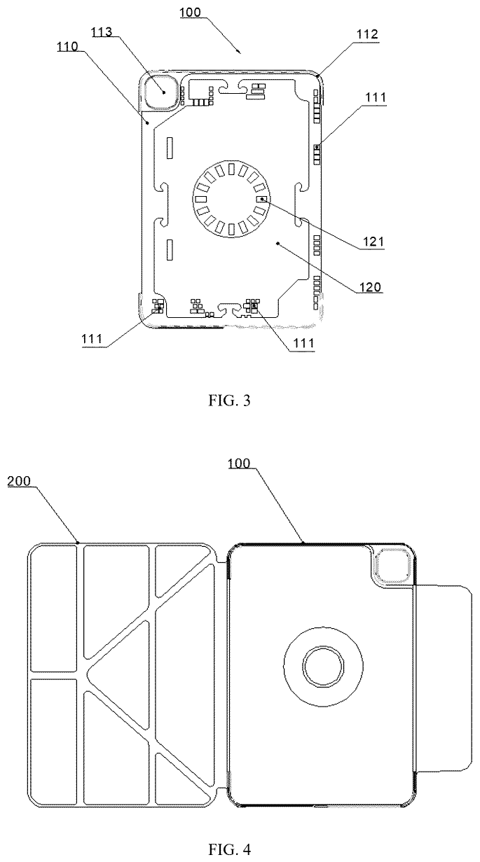

As shown in FIGS. 2 and 3, in this embodiment of the present disclosure, the bottom plate includes an outer frame plate 110 and an inner plate 120 located inside the outer frame plate 110. The four protective corners 112 are integrally formed on the four outer corners of the outer frame plate 110; a hardness of the inner plate 120 is higher than that of the outer frame plate 110. Both the outer frame plate 110 and the inner plate 120 are embedded with a first magnet 111, and a second magnet 121 is embedded on the inner plate 120. In an implementation mode, the outer frame plate 110 and the inner plate 120 can be provided with the first magnet 111 by setting placement holes, and the inner plate 120 can also place the second magnet 121 by setting placement holes. Then, the outer protective pad 130 is configured to wrap and fix, where the inner plate 120 is a fiberglass plate and the outer frame plate 110 is a PC plate. It can be understood that the material of the inner plate 120 is not limited to fiberglass plate, and other high hardness plates can also be used. The material of the outer frame plate 110 is not limited to the PC plate, and other hard plastic plates can also be used.

As shown in FIG. 1, the outer frame plate 110 is provided with an avoidance hole 113 that is compatible with a camera module of the tablet computer. The avoidance hole 113 is determined according to models of the tablet computer. Common tablet computers such as Apple tablet computers, Huawei tablet computers, and Xiaomi tablet computers have slightly different shapes and sizes.

Embodiment 2 further includes a flip cover plate 200, which is used in combination with the shell 100.

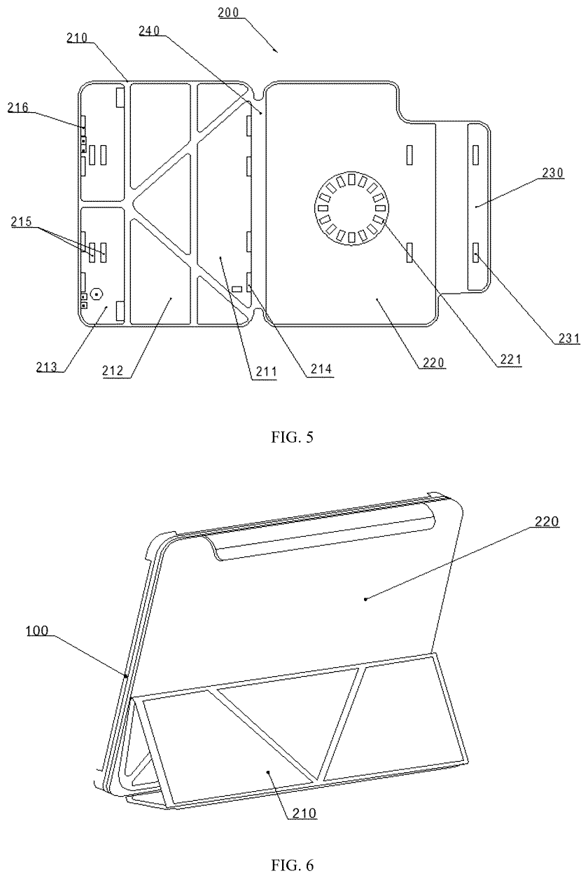

As shown in FIGS. 4 and 5, the flip cover plate 200 includes a cover plate 210, a back plate 220, a buckle 230, and a connection pad 240. The cover plate 210, the back plate 220, and the buckle 230 are arranged at intervals in sequence. The connection pad 240 wraps around the cover plate 210, the back plate 220, and the buckle 230, thereby forming a detachable structural component that wraps around the shell 100. A middle of the back plate 220 is embedded with a third magnet 221, which is configured to magnetically cooperate with the second magnet 121. The buckle 230 can be detachably connected to the cover plate 210.

In an implementation mode, the back plate 220 is made of magnetic iron material. By using the first magnet 111, the second magnet 121, and a magnet of the back plate 220 in combination, the shell 100 can be attached to the back plate 220, and due to many magnetic attraction points, placement angles of the shell 100 can be varied.

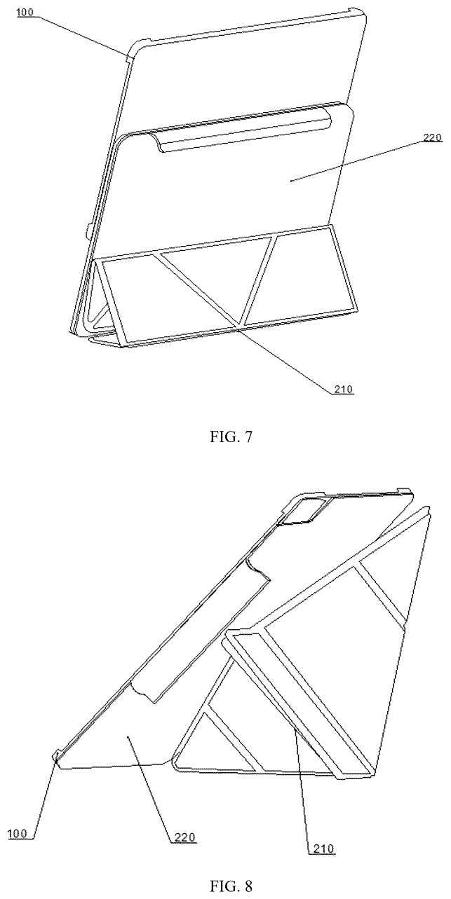

As shown in FIG. 5, the cover plate 210 includes a first cover plate body 211 arranged near the back plate 220, a third cover plate body 213 arranged away from the back plate 220, and a second cover plate body 212 located between the first cover plate body 211 and the third cover plate body 213. The first cover plate body 211 is embedded with a first cover plate magnet 214 on one side close to the back plate 220, and the third cover plate body 213 is embedded with a second cover plate magnet 215 and a third cover plate magnet 216 on one side away from the back plate 220. The third cover plate magnet 216 can magnetically attract and cooperate with the first cover plate magnet 214. In an implementation mode, there are three first cover plate bodies 211, the first cover plate body 211 in the middle is an isosceles ladder structure and two first cover plate bodies 211 at two sides are triangles. The three first cover plate bodies 211 can be spliced into a long square structure. There are three second cover plate bodies 212, two second cover plate bodies 21 at two sides are right angled trapezoidal structures and the one in the middle is an isosceles triangular structure, the three second cover plate bodies 212 can be spliced into a long square structure; the second cover plate body 212 is two pieces of rectangular structure. When the cover plate 210 is used as a bracket, this embodiment can fold the cover plate 210 into different usage forms of brackets as shown in FIGS. 6-8 to meet the support requirements of the tablet computer in different usage states. When folded into styles of FIGS. 6 and 7, the third cover plate magnet 216 and the first cover plate magnet 214 magnetically cooperate to increase the stability of the bracket. When folded into a style of FIG. 8, four second cover plate magnets 215 and four third cover plate magnets 216 are magnetically connected to each other, which can increase the stability of the bracket. It should be noted that the cover plate 210 can also be folded into other styles.

In this embodiment of the present disclosure, there are two rows of second cover plate magnets 215 along a width direction of the third cover plate body 213, and the buckle 230 is embedded with lap joint magnets 231 that can be magnetically attracted to the two rows of second cover plate magnets 215. When the lap joint magnets 231 are magnetically attracted to the second cover plate magnet 215 near the second cover plate body 212, the buckle 230 is in close contact with the shell 100. When the lap joint magnets 231 are magnetically attracted to the second cover plate magnet 215 far away from the second cover plate body 212, a space for accommodating a stylus can be formed between the buckle 230 and the shell 100. The two rows of second cover plate magnets 215 can be selected according to user needs.

In this embodiment of the present disclosure, both the first cover plate body 211 and the third cover plate body 213 are embedded with a dormancy magnet 217, which cooperates with a Hall sensor of the tablet computer. When the cover plate 210 is covered on the tablet computer, the tablet computer system executes sleep according to the magnetic field change detected by the Hall sensor. Conversely, when the cover plate 210 is detached from the tablet computer, the tablet computer system executes wake-up function according to the Hall sensor signal.

In this embodiment of the present disclosure, the material of the connection pad 240 and the outer protective pad 130 is leather, silicone or polyester fabric.

Finally, it should be noted that the above embodiments are only used to illustrate the technical solution of the present disclosure, and not to limit it. Although the present disclosure has been described in detail with reference to the aforementioned embodiments, those skilled in the art should understand that they can still modify the technical solutions described in the aforementioned embodiments, or equivalently replace some or all of the technical features; and these modifications or substitutions do not deviate from the essence of the corresponding technical solutions from the scope of the technical solutions of each embodiment of the present disclosure. They should all be covered within the scope of the claims and specification of the present disclosure.

What is claimed is:

1. A multifunctional magnetic suction tablet computer protective shell, comprising a shell, wherein the shell comprises a bottom plate and an outer protective pad,
the bottom plate is embedded with a first magnet corresponding to a position of a built-in magnet of a tablet computer, and the first magnet is configured to magnetically cooperate with the built-in magnet of the tablet computer;
four corners of the bottom plate are respectively provided with four protective corners that correspond to four corners of the tablet computer, and the outer protective pad is wrapped around the bottom plate and the first magnet.

2. The multifunctional magnetic suction tablet computer protective shell according to claim 1, wherein a second magnet is embedded in a middle of the bottom plate, and there is a gap between the second magnet and the first magnet.

3. The multifunctional magnetic suction tablet computer protective shell according to claim 2, wherein the bottom plate comprises an outer frame plate and an inner plate located inside the outer frame plate, and
the four protective corners are integrally formed on four outer corners of the outer frame plate,
a hardness of the inner plate is higher than a hardness of the outer frame plate.

4. The multifunctional magnetic suction tablet computer protective shell according to claim 3, wherein the outer frame plate is provided with an avoidance hole adapted to a camera module of the tablet computer.

5. The multifunctional magnetic suction tablet computer protective shell according to claim 3, wherein the inner plate is a fiberglass plate, and the outer frame plate is a PC plate.

6. The multifunctional magnetic suction tablet computer protective shell according to claim 2, further comprising a flip cover plate,
wherein the flip cover plate comprises a cover plate, a back plate, a buckle, and a connection pad,
wherein the cover plate, the back plate, and the buckle are sequentially spaced apart,
the connection pad is wrapped on the cover plate, the back plate, and the buckle, so that the flip cover plate forms a detachable structural component wrapped around the shell;
a third magnet is embedded in a middle of the back plate,
wherein the third magnet is configured to magnetically cooperate with the second magnet, and the buckle is detachably connected to the cover plate.

7. The multifunctional magnetic suction tablet computer protective shell according to claim 6, wherein the back plate is made of magnetic iron material.

8. The multifunctional magnetic suction tablet computer protective shell according to claim 6, wherein the cover plate comprises a first cover plate body arranged near the back plate, a third cover plate body arranged far away from the back plate, and a second cover plate body located between the first cover plate body and the third cover plate body,
wherein a first cover plate magnet is embedded on one side of the first cover plate body near the back plate, and a second cover plate magnet and a third cover plate magnet are embedded on one side of the third cover plate body far away from the back plate;
the third cover plate magnet is capable of magnetically cooperating with the first cover plate magnet.

9. The multifunctional magnetic suction tablet computer protective shell according to claim 8, wherein there are two rows of second cover plate magnets arranged along a width direction of the third cover plate body,
the buckle is embedded with lap joint magnets that magnetically cooperate with the two rows of second cover plate magnets.

10. The multifunctional magnetic suction tablet computer protective shell according to claim 6, wherein a material of the connection pad is leather, silicone or polyester fabric.
